(19) United States
(12) Patent Application Publication
(10) Pub. No.: US 2009/0120115 A1
(43) Pub. Date: May 14, 2009

(54) Diesel truck battery disclosure

(76) Inventor: David Hamilton, Bear Lake, MI (US)

Correspondence Address: Douglas S. Bishop;Bishop & Heintz, P.C., P.O. Box 707, Traverse City, MI, 49685-0707, US

(21) Appl. No.: 11/985,090

(22) Filed: Nov. 14, 2007

(51) Int. Cl. B60H 1/32; F25B 27/00

(52) U.S. Cl. 62/236; 62/244; 62/323.3

(57) ABSTRACT

A diesel truck air conditioning system operable automatically on battery power when the main diesel engine is inactive and to restart a motor upon relay sensing a minimum voltage. An auxiliary battery bank is charged by a separately fuel powered vehicle generator and which returns power to the motor portion of the generator for in turn operating an AC pump to which it is connected. A voltage sensor/relay feature enables either automatically activating a fuel powered version of the generator or, according to a secondary version, restarting the engine to run the generator and thereby recharge the separate battery bank. In an additional variant, the use of the generator heat exhaust can be convected within a fluid jacket to provide heat from the operation of the vehicle generator, such as which can be used within the cab of the vehicle.

### FIELD OF THE INVENTION

The present invention relates generally to a diesel truck air conditioning system which is operable automatically on battery power when the main diesel engine is inactive. More specifically, the present invention discloses an auxiliary battery for powering an on-board AC unit upon engine shutdown and to restart a motor upon relay sensing a minimum voltage.

### BACKGROUND OF THE INVENTION

The prior art is documented with various types of air conditioning systems for use with land vehicles. Such assemblies typically incorporate a generator and battery arrangement in cooperation with a main source of propulsion, i.e., an engine, in order to such as provide for charging of the battery through the generator.

One such example is set forth in U.S. Pat. No. 6,874,330, to Iritani, and which teaches a unit for performing an air conditioning operation by electrical power supplied from a battery. Upon a residual charging degree of the battery: becoming equal to or lower than a preset target degree, an electrical motor generator is driven by a vehicle engine so that the battery is charged through the electrical motor generator. Further, and upon a rotational speed of the engine being lower than a predetermined speed or when a power generation efficiency due to the engine is lower than a predetermined efficiency, air-conditioning capacity of the AC unit is set lower, so that a consumption power of the AC is restricted. In this fashion, the frequency is reduced for starting the engine for the sole purpose of charging the battery.

U.S. Patent Publication No. 2003/0141049, to Kennedy, teaches an auxiliary system for trucks and which includes a small diesel engine coupled to an air conditioner compressor and an automotive style DC alternator. During hot weather, the auxiliary engine rotates the AC compressor to provide cool air to the truck accessories, with load management controlling of alternator current output to provide DC power to accessories and for battery charging. Upon occurrence of a peak load condition, the voltage is reduced into the field of the alternator in a form of load management wherein the truck batteries act as a power sink and the alternator is used to replenish any power drawn from the truck batteries when the peak demand is removed. During cold weather the engine coolant is used to cool the auxiliary engine and is circulated through a heat exchanger for warming of the truck interior, the full capacity of the alternator being allowed to accommodate the higher amperage drawing typical of cold weather diesel operation.

U.S. Pat. No. 6,889,762, issued to Ziegler, discloses an AC system for use in an over-the-road or off-road vehicle and which provides for operation during both engine on and off conditions. The system utilizes a variable speed, motor driven compressor controlled by an intelligent power generation management controller and which selects from one of the available sources of power on the vehicle to drive the compressor and modulates the compressor speed and capacity based upon the operational parameters and source availability and depletion. The controller may also operate a coolant or air heater to provide heating to the interior compartments.

Finally, U.S. Pat. No. 5,125,236, issued to Clancey et al., teaches a combined generator set and air conditioning compressor drive system for use in a mobile vehicle. Components of the device include an auxiliary engine, a compressor, and a motor-generator. Upon the existence of an unavailability condition of an external source of energy, the motor-generator shaft is driven by the auxiliary engine and operated as a generator to provide electricity to the vehicle. The compressor is also shaft driven and, upon the external source of electricity again becoming available, the motor generator resumes operation of the motor to drive the compressor.

### SUMMARY OF THE INVENTION

The present invention discloses an improved auxiliary power system for operating an AC unit, upon disengagement of a vehicle engine. More specifically, the invention teaches a diesel truck air conditioning system which is operable automatically on battery power when the main diesel engine is inactive. Also disclosed is an auxiliary battery for powering an on-board AC unit upon engine shutdown and to restart a motor upon relay sensing a minimum voltage.

In operation, an auxiliary battery bank is charged by the vehicle generator and which returns power to the motor portion of the generator for in turn operating an AC pump to which it is connected. A voltage sensor/relay feature enables either automatically activating a fuel powered version of the generator or, according to a secondary version, restarting the engine to run the generator and thereby recharge the separate battery bank. In an additional variant, the use of the generator heat exhaust can be convected within a fluid jacket to provide heat from the operation of the vehicle generator, such as which can be used within the cab of the vehicle.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of a first variant of the present inventions and which includes an air conditioning pump and DC electric motor, in turn coupled directly to an alternator arrangement for self-starting and shutting off a vehicle motor for recharging and maintaining a bank of batteries operating the AC unit;

FIG. 2 is a perspective view of a further variant substituting a hydraulic motor for the DC electric motor of FIG. 1;

FIG. 3 is a perspective view of a still further variant incorporating an AC electric motor; and

FIG. 4 is an illustration of an additional variant incorporating use of a generator heat exhaust convected within a fluid jacket to provide heat from the operation of the vehicle generator, and such as which can be used within the cab of the vehicle.

### DETAILED DESCRIPTION OF THE PREFERRED EMBODIMENTS

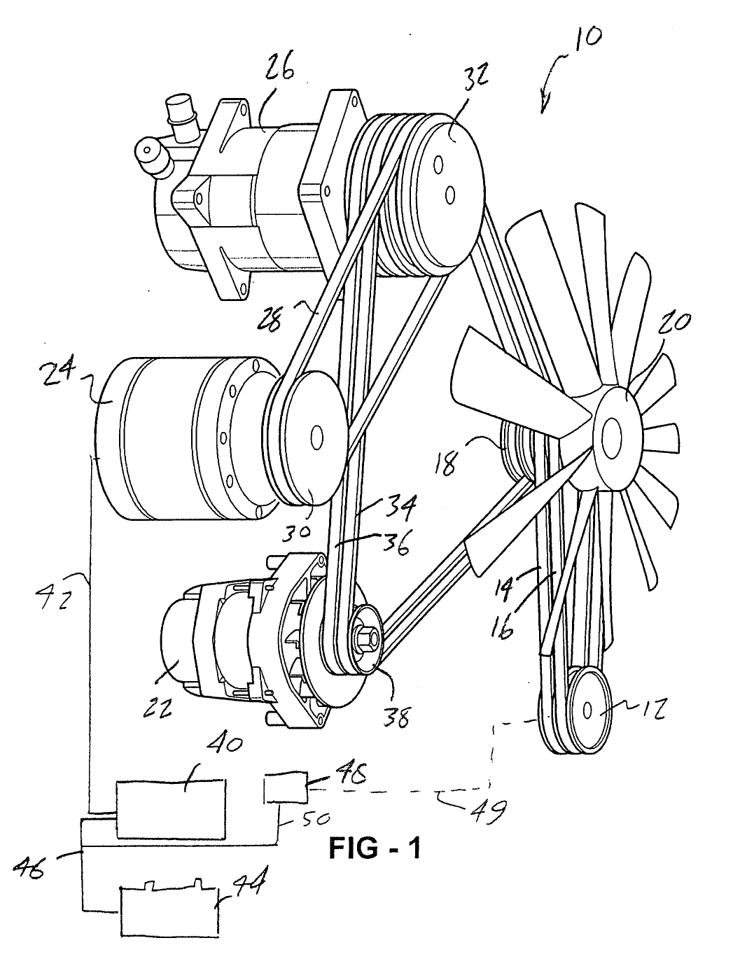

Referring now to FIG. 1, an illustration is generally shown at 10 of an auxiliary battery system incorporated into a vehicle air conditioning system, in one preferred application a diesel truck air conditioning system. As previously described, the present invention discloses an air conditioning system which is operable automatically on battery power when the main diesel engine is inactive. More specifically, the present invention discloses an auxiliary battery for powering an on-board air conditioning unit upon engine shutdown and to restart a motor upon relay sensing a minimum voltage. As will be described in further detail, it is contemplated that an operational voltage range of 24-90 volts is established, and depending upon the horsepower rating of the associated engine.

General components associated with the illustration FIG. 1 include an engine, Diesel or other type of primary vehicle motor, and which is represented by a rotary output prop 12 which drives a pulley, see as generally referenced at 14 and 16, the pulley interconnecting a further rotary output component 18 with a multi-bladed hub 20. Additional features include an alternator 22, a DC electric motor 24 (also incorporating a generator component as will be subsequently described) and an air conditioning unit/pump subassembly 26. The air conditioning pump 26 and electric motor 24 both include a magnetic clutch (not shown), this controlling operation of a pulley 28 rotatably slaving a rotary component 30 of the motor 24 with an associated rotary component 32 of the AC unit 26.

A further triangular pulley, represented by aligning belt locations 34 and 36, extends from a further location associated with the rotary drive component 32 of the AC unit 26, and in likewise engaging fashion at points of the triangular shape to further rotary drive components 38 (associated with the alternator 22) and at 18 (again associated with the engine output prop 12.

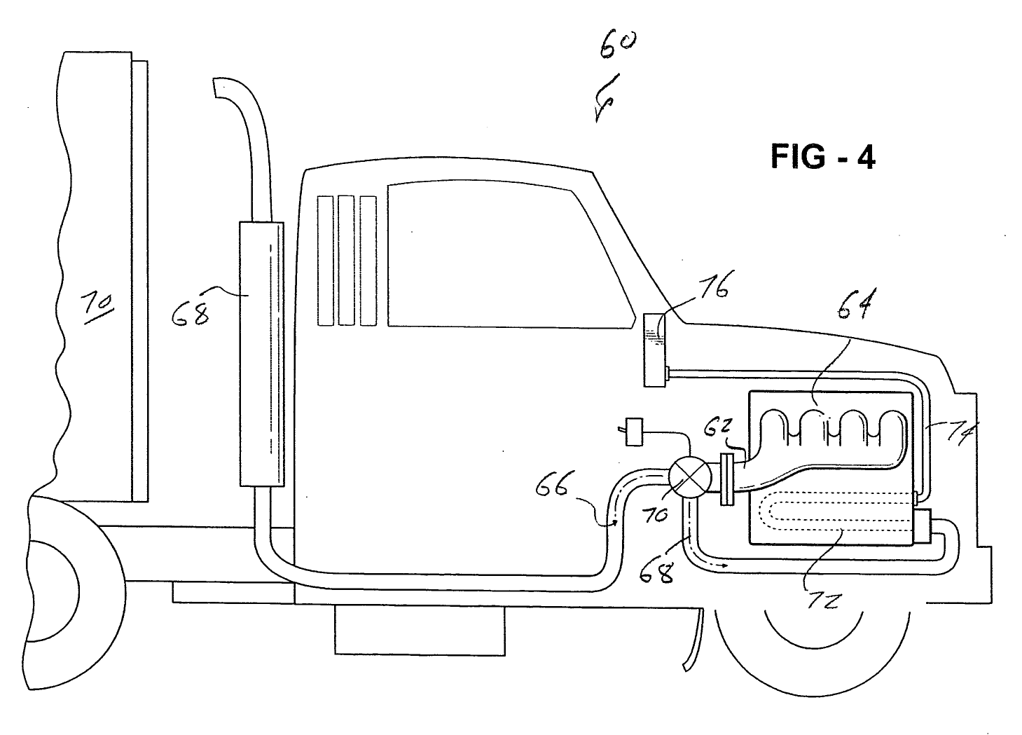

A series of low and high pressure switches (not shown) are employed to control an amount of head pressure existing in the AC unit 26, and which is selectively activated by a switching system built into the dash of the vehicle (not shown). During normal engine operation, the engine motor (see output 12) in addition to its cooperating driving of the AC unit 26 (see via pulleys 14 and 16 which engage rotary component 32) and the vehicle alternator 22 (via again rotary component 38) concurrently turns a generator 40, see as representatively shown and which is understood to be powered by a separate fuel supply (not shown) and operatively connected to the DC motor 24, see line 42. It is also envisioned and understood that the AC unit 26 utilizes existing air conditioning and heating ducts, and such as which are originally designed and manufactured into the vehicle. Reference is also made to subsequent FIG. 4, and which existing heat register (at 76) and other known ductwork components can be adopted into the present design.

Operation of the generator 40 in turn charges a separate battery bank, representatively shown by battery 44 connected via line 46 to the generator 40. While only a single battery 44 is representatively shown, it is understood that a suitable battery bank may include a larger plurality of batteries or also a single and appropriate sized batteries as dictated by the requirements of the given application (e.g. engine type, load requirements of the AC unit, etc.).

As further understood, the DC electric motor 24 powers the AC unit 26 when the (diesel) motor is not operating. At this point, the series of DC batteries, again as generally referenced at 46, supply electric power (such as again in a 24-90 V range), though its interconnection with the generator 40, and in order to operate the DC electric motor 24.

Upon sensing a predetermined drop in power, this being signaled to such as a control module representatively shown at 48 and in communication (via line 50) with the battery bank output line 46 (or alternatively incorporated into the fuel powered generator 40), the control module 48 instructs the generator 40 restart and to in turn provide electric power of the AC unit 26, in the manner previously described. The voltage sensor/relay feature associated with the module 48, alternatively to enabling automatically activating a fuel powered version of the generator 40, may also be employed to restart the engine (referenced by rotary output component 12), see also line 49 extending therebetween, to run the generator (via the architecture previously described) and thereby recharge the separate battery bank

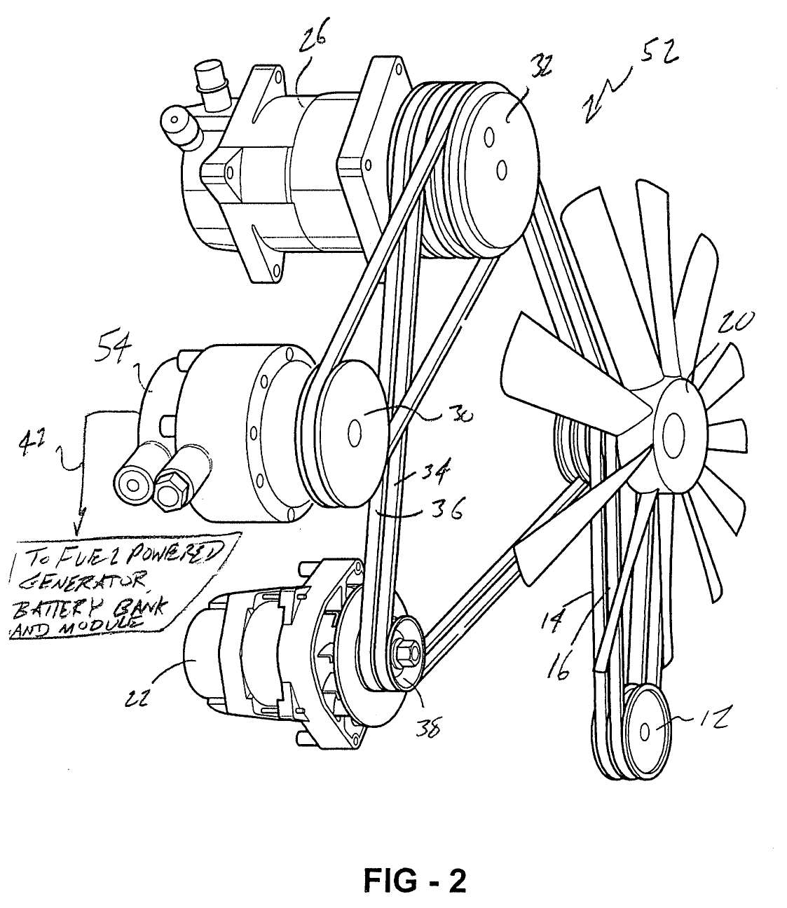

Referring to FIG. 2, a perspective view is shown at 52 of a further variant substituting a hydraulic motor 54 for the DC electric motor 24 of FIG. 1. Identical components are repetitively referenced and the fuel powered generator, battery bank and control module of FIG. 1 are collectively referenced in representative fashion in communication with line 42 extending to the motor 54. The arrangement of FIG. 2 is operationally similar to that described in FIG. 1, with the DC hydraulic motor being supplied with oil from a hydraulic pump and as is known in the art. It is further envisioned that the hydraulic motor 54 can also be powered from any gas, diesel or DC power sources.

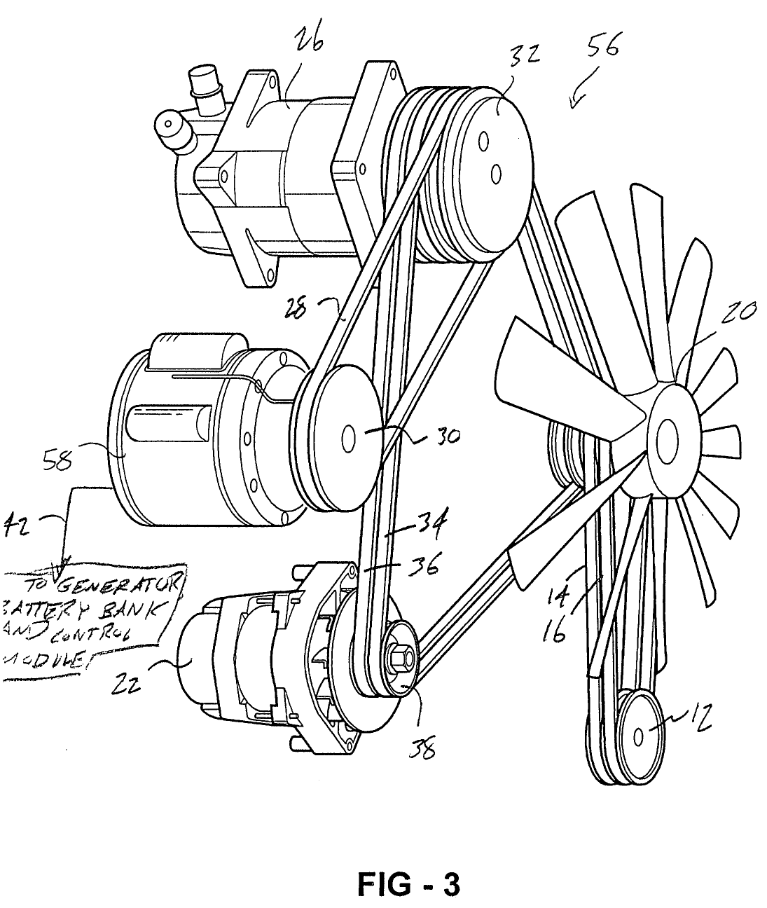

FIG. 3 illustrates at 56 a perspective view of a still further variant incorporating an AC electric motor 58, and in substitution of either the DC electric motor 24 of FIG. 1, or the hydraulic motor 54 of FIG. 2. The arrangement of FIG. 3, as with FIG. 3, operates along the same principles as previously described for FIG. 1.

Referring to FIG. 4, an illustration is shown at 60 of an additional variant incorporating use of a generator heat exhaust, see as generally shown at 62 in the schematic illustrated and which extends from the motor compartment 64 of the vehicle. The heat exhaust 62, in addition to being vented via interconnecting pipe 66 extending to a conventional exhaust 68, is split to a second pipe 68 via such as a ball valve 70 and which can be operated to channel the heated engine exhaust to either the disposal pipe 66 or the secondary pipe 68.

The pipe 68 communicates with a fluid (typically water but also contemplated to include glycol or other suitable fluid based heat transfer mediums) contained within a jacket, see at 72 and which is defines such as a hairpin turn incorporated into the motor compartment 64. In this fashion, and upon adjusting the position of the ball valve 70 to direct the (moderately heated and pressurized) exhaust flow through the secondary pipe 68. The exhaust heat convectively warms the water within the fluid jacket 72, an output of which communicates, see line 74, to such as a heat register 76 associated with a location of the vehicle (truck cab) and in order to provide heat from the operation of the vehicle (motor and generator), and such as which can be used within the cab of the vehicle.

The principles of this application contemplate incorporating any suitable fans, heat transfer components or the like known in the art and to effectuate the convective heating of the water jacket 72, and the transferrance of that heat to an airstream introduced into the passenger compartment of the vehicle. It is also understood that suitable safeguards are employed to prevent the possibility of any exhaust fumes, carbon monoxide or the like to enter the passenger compartment of the vehicle.

Accordingly, the present invention discloses a novel and improved mechanism for iteratively recharging a separate battery bank communicating with both a suitable AC/DC electric or hydraulic motor, through an associated fuel powered generator and separate monitoring control module. The air conditioning unit, such as shown at 26, is incorporated into such as a commercial refrigeration unit associated with the truck/vehicle, the importance being appreciated of carefully maintaining a refrigerated/freezer environment for product contained within an enclosed storage volume (see as referenced at 70 in FIG. 4)

Having described my invention, other and additional preferred embodiments will become apparent to those skilled in the art to which it pertains, and without deviating from the scope of the appended claims:

I claim:

1. An auxiliary power system incorporated into a vehicle engine, comprising:
a primary vehicle motor having a rotatable output drive;
a first pulley communicating said output drive to a further rotary output component;
a second pulley interconnecting said further rotary output component with associated rotary components associated with each of an alternator and an air conditioning subassembly;
a secondary motor including a separate generator in operative communication with said air conditioning subassembly via a third pulley;
at least one battery electrically communicating with said generator and, via said generator, with said secondary motor;
upon deactivation of said primary vehicle motor, said batteries powering said generator for in turn operating said secondary motor to rotate said third pulley and operate said air conditioning subassembly; and
a control module in operative communication with an output line associated with said battery and, upon registering a predetermined loss of power, reactivating at least said secondary motor to in turn operate said generator to power said air conditioning subassembly.

2. The system as described in claim 1, said secondary motor further comprising at least one of an AC motor, a DC motor, and a hydraulic motor.

3. The system as described in claim 1, said at least one battery further comprising a battery bank in communication with said generator and said control module.

4. The system as described in claim 1, said control module further being in operative communication with said primary vehicle motor and re-activating the same upon registering said predetermined loss of power.

5. The system as described in claim 1, said control module further comprising a relay for instructing reactivation of said at least second motor upon reading a signal indicative of said predetermined loss of power.

6. The system as described in claim 1, further comprising a generator created heat exhaust being redirected from a conventional exhaust to a fluid jacket incorporated into a motor compartment, the exhaust heat convectively warming a fluid within the fluid jacket a further heat conversion application converting heated fluid to an output heated air flow released within a passenger cab of the vehicle.

7. The system as described in claim 6, further comprising a ball valve for splitting the generator created heat exhaust between a first pipe communicating with said conventional exhaust and a second pipe communicating with said fluid jacket.

8. The system as described in claim 7, said fluid jacket further comprising a hairpin configuration embedded within the motor compartment.

9. The system as described in claim 3, said battery bank exhibiting a specified shape and size and providing an operational voltage range of between 24-90 volts.

10. The system as described in claim 2, said hydraulic motor having a specified shape and size and further comprising a power source derived from at least one of a gasoline, diesel and DC input.

11. The system as described in claim 1, said air conditioning subassembly exhibiting a specified shape and size and adapted to being communicated with existing ductwork associated with a vehicle.
